(19) United States
(12) Patent Application Publication
(10) Pub. No.: US 2025/0236821 A1
(43) Pub. Date: Jul. 24, 2025

(54) FLUORINATED CLEANING FLUID

(71) Applicant: 3M INNOVATIVE PROPERTIES COMPANY, St. Paul, MN (US)

(72) Inventors: Rama V. Rajagopal, Singapore (SG); Nobuaki Ando, Kanagawa (JP); Yusuke Saito, Tokyo (JP)

(21) Appl. No.: 18/697,801

(22) PCT Filed: Sep. 26, 2022
(86) PCT No.: PCT/IB2022/059122

§ 371 Date: Apr. 2, 2024

Related U.S. Application Data
(60) Provisional application No. 63/253,168, filed on Oct. 7, 2021.

(51) Int. Cl. C11D 7/50

(52) U.S. Cl. CPC C11D 7/5018; C11D 7/5009

(57) ABSTRACT

Cleaning fluids include at least 2 fluid components. The first fluid component is a chlorinated hydrofluoroolefin, a hydrochlorofluoroolefin, or a mixture of hydrochlorofluoroolefins. The second fluid component includes at least one of a hydrofluorothioether, a perfluorinated olefin with at least 6 carbon atoms, a hydrofluorolefin with at least 6 carbon atoms, a perfluorinated olefin mixture where the perfluorinated olefins have at least 6 carbon atoms, or a hydrofluorolefin mixture where the hydrofluorolefins have at least 6 carbon atoms.

### SUMMARY

Disclosed herein are cleaning fluids that comprise at least 2 fluid components. In some embodiments the cleaning fluid comprises a first fluid component comprising a chlorinated hydrofluoroolefin or a hydrochlorofluoroolefin or mixture of hydrochlorofluoroolefins, and at least one second fluid component. The second fluid component comprises at least one of a hydrofluorothioether, a perfluorinated olefin comprising at least 6 carbon atoms, a hydrofluorolefin comprising at least 6 carbon atoms, a perfluorinated olefin mixture wherein the perfluorinated olefins comprise at least 6 carbon atoms, or a hydrofluorolefin mixture wherein the hydrofluorolefins comprise at least 6 carbon atoms.

### DETAILED DESCRIPTION

Cleaning fluids are used in a wide range of applications, especially in transportation applications. This includes not only the cleaning of vehicles, such as bicycles, automobiles, trucks, trains, aircraft, and the like, but also parts of these vehicles such as bodies, brake components, suspensions, wheels, and the like, and tools used to repair and maintain these vehicles. Often the dirt associated with these applications is oily dirt. For these applications, conventional cleaners such as soaps and detergents, which are aqueous compositions, are generally not suitable. Hydrocarbon cleaning fluids such as aromatics (e.g. benzene and toluene) or alkanes (e.g. hexanes and petroleum ether) or mixtures such as gasoline can be useful against oily dirt, but these materials are flammable and therefore hazardous to use as cleaners. A range of chlorinated solvents have been developed that provide good oily dirt removal from metal surfaces and are non-flammable, but these materials have drawbacks. These drawbacks are especially problematic when the articles to be cleaned contain polymeric materials. These chlorinated solvents tend to dissolve or swell the polymeric materials that are becoming increasing common in transportation vehicles and parts. Mixtures of chlorinated solvents and hydrocarbon solvents can also be used, but these likewise have drawbacks. As mentioned above, the hydrocarbon solvents are flammable and thus can be hazardous. Additionally, since the hydrocarbon solvents have a higher surface tension, the use of these solvents in combination with chlorinated solvents can produce a less effective cleaner, especially for penetrating into small spaces in articles.

Therefore, the need remains for cleaning fluids that are effective against oily dirt, have a low surface tension to permit penetration into small spaces on surfaces, are non-flammable, and are compatible with a range of polymeric materials such as rubbers and plastics. Additionally, it is desirable that cleaning fluids achieve these properties and are also non-toxic environmentally friendly.

Disclosed herein are cleaning fluids that are mixtures of fluids that provide the desired performance properties of effective cleaning against oily dirt, low surface tension, non-flammability, compatibility with a range of polymeric materials such as rubbers and plastics and are also environmentally friendly and non-toxic.

In some embodiments, the cleaning fluid comprises at least two fluid components. The first fluid component comprises a chlorinated hydrofluoroolefin or a hydrochlorofluoroolefin or mixture of hydrochlorofluoroolefins. The second fluid component comprises a hydrofluorothioether, a perfluorinated olefin comprising at least 6 carbon atoms, a hydrofluorolefin comprising at least 6 carbon atoms, a perfluorinated olefin mixture where the perfluorinated olefins have at least 6 carbon atoms, or a hydrofluorolefin mixture where the hydrofluorolefins have at least 6 carbon atoms.

In other embodiments, the cleaning fluid comprises at least three fluid components. The first fluid component comprises a chlorinated hydrofluoroolefin or a hydrochlorofluoroolefin or mixture of hydrochlorofluoroolefins. The second fluid component comprises a hydrofluorothioether. The third fluid component comprises a perfluorinated olefin comprising at least 6 carbon atoms, a hydrofluorolefin comprising at least 6 carbon atoms, a perfluorinated olefin mixture where the perfluorinated olefins have at least 6 carbon atoms, or a hydrofluorolefin mixture where the hydrofluorolefins have at least 6 carbon atoms.

As used herein, “fluoro-” (for example, in reference to a group or moiety, such as in the case of “fluoroalkylene” or “fluoroalkyl” or “fluorocarbon”) or “fluorinated” means (i) partially fluorinated such that there is at least one carbon-bonded hydrogen atom, or (ii) perfluorinated.

As used herein, “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, there are no carbon-bonded hydrogen atoms replaceable with fluorine.

As used herein, the group “—R_{f}” is used according to common usage in chemical arts and refers to fluoralkyl group. The group “—Rr-” refers to a fluoroalkylene group.

The terms “room temperature” and “ambient temperature” are used interchangeably to mean temperatures in the range of 20° C. to 25° C.

The term “alkyl” refers to a monovalent group that is a radical of an alkane, which is a saturated hydrocarbon. The alkyl can be linear, branched, cyclic, or combinations thereof.

The term “olefin” is used herein as is well understood in the chemical arts, referring to a molecule with an olefinic group, that is to say a carbon-carbon double bond (—C═C—). which may be terminal or non-terminal. Groups with olefinic groups include chlorinated hydrofluoroolefins which are olefinic groups with a chlorine atom, 2 hydrogen atoms, and a fluorinated group attached; hydrochlorofluoroolefins which are olefinic groups with a chlorine atom, a fluorine atom, a hydrogen atom, and a fluorinated group attached; perfluorinated olefins are olefin groups where all of the hydrogen atoms have been replaced by fluorine atoms; and hydrofluoroolefins are olefin groups that contain at least one hydrogen atom as well as fluorine atoms.

The term “ether” as used herein refers to a compound of the type R^{a}—O—R^{b}, where R^{a} and R^{b} are alkyl, or fluorinated alkyl groups. The term “thioether” refers to an ether compound where the oxygen is replaced by a sulfur atom. The term “hydrofluorothioether” as used herein refers to a thioether of the type R^{a}—S—R^{b}, where R^{a} is an alkyl group and R^{b} is fluorinated alkyl group, typically a perfluoroalkyl group.

Disclosed herein are cleaning fluids that comprise mixtures of fluid components. In some embodiments, the cleaning fluid comprises at least two fluid components. The cleaning fluid comprises a first fluid component comprising a chlorinated hydrofluoroolefin, a hydrochlorofluoroolefin, or mixture of hydrochlorofluoroolefins. The cleaning fluid also comprises a second fluid component comprising at least one of a hydrofluorothioether, a perfluorinated olefin comprising at least 6 carbon atoms, a hydrofluorolefin comprising at least 6 carbon atoms, a perfluorinated olefin mixture wherein the perfluorinated olefins comprise at least 6 carbon atoms, or a hydrofluorolefin mixture wherein the hydrofluorolefins comprise at least 6 carbon atoms. Each of these components is described in greater detail below.

The cleaning fluid comprises a first fluid component comprising a chlorinated hydrofluoroolefin, a hydrochlorofluoroolefin, or mixture of hydrochlorofluoroolefins. In some embodiments, the first fluid component comprises a chlorinated hydrofluoroolefin of Structure 1.

cis-(CF₃)HC═CHCl; Structure 1

The cis nomenclature is used herein and is equivalent to the Z nomenclature. The chlorinated hydrofluoroolefin is commercially available as CELEFIN-1233z from Central Glass Co., Ltd. Tokyo, Japan. While the cis isomer is shown in the structure, it is well understood in the chemical arts that some trans isomer might also be present in the fluid.

In other embodiments, the first fluid comprises a hydrochlorofluoroolefin or a mixture of hydrochlorofluoroolefins. The first fluid comprises at least one of the two isomers of hydrochlorofluoroolefin of Structure 2,

HClC═CF(CF₂H) Structure 2

at least one of the two isomers of hydrochlorofluoroolefin of Structure 3,

FClC═CH(CF₂H) Structure 3

or a mixture of two, three or all four of the isomers.

A mixture of the isomers of Structures 2 and 3 is commercially available as AMOLEA AS-300 from (AGC) Asahi Glass Company, Tokyo, Japan.

In some embodiments, the first fluid component may comprise a mixture of chlorinated hydrofluoroolefin and hydrochlorofluoroolefin(s).

The amount of the first fluid component in the cleaning fluid can vary over a wide range. The first fluid component is a very effective cleaning fluid for oily dirt but can have compatibility issues with polymeric materials. In some embodiments, the first fluid component comprises 30-95% by weight of the total of the first and second fluid components of the cleaning fluid. In other embodiments, the first fluid component comprises 30-70% by weight of the total of the first and second fluid components of the cleaning fluid. In yet other embodiments, the first fluid component comprises 40-50% by weight of the total of the first and second fluid components of the cleaning fluid.

The cleaning fluid further comprises at least one additional fluid component called a second fluid component. The second fluid component provides compatibility with a wide range of substrates. As mentioned above, the first fluid component provides effective cleaning properties but lacks compatibility with a number of substrate surfaces, especially polymer substrate surfaces. Combining the first fluid component with at least one second fluid component increases the compatibility with a wide range of substrate surfaces while preserving the good cleaning properties of the first fluid.

The at least one second fluid component comprises at least one of a hydrofluorothioether, a perfluorinated olefin comprising at least 6 carbon atoms, a hydrofluorolefin comprising at least 6 carbon atoms, a perfluorinated olefin mixture wherein the perfluorinated olefins comprise at least 6 carbon atoms, or a hydrofluorolefin mixture wherein the hydrofluorolefins comprise at least 6 carbon atoms.

In some embodiments, the second fluid component comprises a hydrofluorothioether comprising structure 4:

R¹—S—CR_{f}¹R_{f}²F Structure 4

wherein R¹ is an alkyl group with 1-3 carbon atoms; and R_{f}¹ and R_{f}² are independently selected from perfluorinated alkyl groups with 1-3 carbon atoms. In some embodiments, R¹ is a methyl group and both R_{f}¹ and R_{f}² are perfluorinated methyl groups.

In other embodiments, the second fluid component comprises a perfluorinated olefin comprising at least 6 carbon atoms, or mixture of perfluorinated olefins comprising at least 6 carbon atoms. Examples of suitable materials include DR CFX70 (Chemours-Mitsui Fluoroproducts Co.).

In other embodiments, the second fluid component comprises a hydrofluorolefin comprising at least 6 carbon atoms, or a mixture of hydrofluorolefins comprising at least 6 carbon atoms. Examples of suitable materials include OPTEON SF-10 (Chemours Chemical Co.).

Also disclosed herein are cleaning fluids that comprise at least three fluid components. While the above “two-component” fluids may comprise more than two fluid components, the three component fluids comprise at least three fluid components. The first fluid component comprises a chlorinated hydrofluoroolefin or a hydrochlorofluoroolefin or mixture of hydrochlorofluoroolefins. The second fluid component comprises a hydrofluorothioether. The third fluid component comprises a perfluorinated olefin comprising at least 6 carbon atoms, a hydrofluorolefin comprising at least 6 carbon atoms, a perfluorinated olefin mixture where the perfluorinated olefins have at least 6 carbon atoms, or a hydrofluorolefin mixture where the hydrofluorolefins have at least 6 carbon atoms.

The first fluid component comprises chlorinated hydrofluoroolefin or a hydrochlorofluoroolefin or mixture of hydrochlorofluoroolefins. These components are described in detail above.

The second fluid component comprises a hydrofluorothioether. This component is described in detail above.

The third fluid component comprises a perfluorinated olefin comprising at least 6 carbon atoms, a hydrofluorolefin comprising at least 6 carbon atoms, a perfluorinated olefin mixture where the perfluorinated olefins have at least 6 carbon atoms, or a hydrofluorolefin mixture where the hydrofluorolefins have at least 6 carbon atoms. These components are described in detail above.

In some embodiments, the three-component cleaning fluid comprises a mixture the first fluid component comprises 30-70% by weight, the second fluid component comprises at least 15% by weight, and the third fluid component comprises at least 15% by weight. The % by weight is the % by weight of the total of the first, second and third fluid components of the cleaning fluid.

The cleaning fluids of this disclosure may also comprise additional optional components. The optional additives should not disrupt the desirable properties of the cleaning fluid. Examples of optional additives that could be used include hydrocarbon solvents, or hydrocarbon-based solvents. Examples include aliphatic hydrocarbons such as hexane and heptane, and hydrocarbon-based solvents such as ketones, esters and alcohols.

As mentioned above, the cleaning fluids of this disclosure have a wide range of desirable properties. The cleaning fluids are non-flammable. Suitable tests for flammability are described in the Examples section.

The cleaning fluids have a boiling point that is suitable for use as cleaning fluid in a wide range of applications. If the fluid has too high of a boiling point, trace residues of the fluid do not evaporate quickly enough from a cleaned surface. On the other hand, if the boiling point is too low, the cleaning fluid is too volatile to provide effective cleaning. The cleaning fluids of this disclosure have a boiling point of less than 100° C.

In some embodiments, the cleaning fluid is sprayable. A wide range of spraying technologies are known for delivering cleaning fluids. Examples include commercial sprayers, including airless sprayers, and aerosols (where the fluid is dispensed from a pressurized vessel such as a can).

The cleaning fluids have desirable compatibility with a wide range of polymeric materials. In this context, compatibility is measured by a weight increase of less than 10% when soaked for 48 hours in the cleaning fluid. Among the compatible plastic and rubber materials are LDPE (low density polyethylene), ABS (acrylonitrile butadiene styrene copolymer), PC (polycarbonate), EPDM (ethylene propylene diene monomer synthetic rubber), CR (chloroprene rubber), SBR (styrene butadiene rubber.

The current cleaning fluids are also environmentally friendly. By this it is meant that the cleaning fluids may have a low environmental impact. In this regard, the fluorinated compounds of the present disclosure may have a global warming potential (GWP, 100 yr ITH) of less than 500, 300, 200, 100, 50, 10, or less than 1. As used herein, GWP is a relative measure of the global warming potential of a compound based on the structure of the compound. The GWP of a compound, as defined by the Intergovernmental Panel on Climate Change (IPCC) in 1990 and updated in 2007, is calculated as the warming due to the release of 1 kilogram of a compound relative to the warming due to the release of 1 kilogram of CO₂ over a specified integration time horizon (ITH).

$${GWP}_{i} ( {t}^{′} ) = \frac{{{\int }^{ITH}}_{0} {a}_{i} [ C ( t ) ] dt}{{{\int }_{0}}^{ITH} {a}_{{CO}_{2}} [ {C}_{{CO}_{2}} ( t ) ] dt} = \frac{{{\int }^{ITH}}_{0} {a}_{i} {C}_{oi} {e}^{- t / {τ}_{i}} dt}{{{\int }_{0}}^{ITH} {a}_{{CO}_{2}} [ {C}_{{CO}_{2}} ( t ) ] dt}$$

In this equation aᵢ is the radiative forcing per unit mass increase of a compound in the atmosphere (the change in the flux of radiation through the atmosphere due to the IR absorbance of that compound), C is the atmospheric concentration of a compound, τ is the atmospheric lifetime of a compound, t is time, and i is the compound of interest. The commonly accepted ITH is 100 years representing a compromise between short-term effects (20 years) and longer-term effects (500 years or longer). The concentration of an organic compound, i, in the atmosphere is assumed to follow pseudo first order kinetics (i.e., exponential decay). The concentration of CO₂ over that same time interval incorporates a more complex model for the exchange and removal of CO₂ from the atmosphere (the Bern carbon cycle model).

### Examples

Unless otherwise noted or readily apparent from the context, all parts, percentages, ratios, etc. in the Examples and the rest of the specification are by weight.

### Materials Used in the Examples

| Material | Description |
|---|---|
| 1233Z | A chlorinated hydrofluoroolefin, available under the trade |
| | designation “CELEFIN-1233Z”, from Central Glass Co., |
| | Ltd. Tokyo, Japan. |
| AS-300 | A mixture of isomers of two hydrochlorofluoroolefins, |
| | HClC═CF(CF₂H) and FClC═CH(CF₂H), available under the |
| | trade designation “AMOLEA AS-300”, from (AGC) Asahi |
| | Glass Company, Tokyo, Japan. |
| SF-70 | A perfluorinated olefin, available under the trade |
| | designation “OPTEON SF-70 and/or DR CFX70”, from |
| | Chemours-Mitsui Flouroproducts Co., Ltd., Tokyo, Japan. |
| HFTE | A hydrofluorothioether, CH₃—S—C(CF₃)₂F, available from |
| | 3M Company, St. Paul, Minnesota. |
| 7100 | A hydrofluoroether, methoxy-nonafluorbutane, available |
| | under the trade designation “3M NOVEC 7100 Engineered |
| | Fluid”, from 3M Company. |
| Hexane | Hexane, available from Sigma-Aldrich, St. Louis, Missouri. |
| LDPE | Low density polyethylene, available under the trade |
| | designation “EH-N-AN”, from Showa Denko Materials Co., |
| | Ltd, Tokyo, Japan. |
| ABS | Acrylonitrile butadiene styrene, available under the trade |
| | designation “EAR-003”, from Sumitomo Bakelite Co., Ltd, |
| | Tokyo, Japan. |
| PC | Polycarbonate, available under the trade designation “PC- |
| | 1600”, from C.I. Takiron Corporation, Osaka, Japan. |
| EPDM | Ethylene propylene diene monomer rubber, available under |
| | the trade designation “TEKL-7007”, from Tigers Polymer |
| | Corporation, Osaka, Japan. |
| SBR | Styrene butadiene rubber, available under the trade |
| | designation “GB660A”, from Maxell Kureha Co, Ltd, |
| | Osaka, Japan. |
| CR | Chloroprene rubber, available under the trade designation |
| | “NM605”, from Nitto Kako Co., Ltd, Kanagawa, Japan. |
| NBR | Nitrile butadiene rubber, available under the trade |
| | designation “TNKL-7007”, from Tigers Polymer |
| | Corporation. |
| Oil 1 | An engine oil, available under the trade designation “SP |
| | OIL E/O OW-20”, from ExxonMobil, Irving, Texas |
| Oil 2 | A gear oil, available under the trade designation “MG |
| | GEAR OIL SPECIAL II”, from ExxonMobil. |
| Grease 1 | A grease, available under the trade designation “1815D”, |
| | from Three Bond Co. Ltd, Hachioji-city, Tokyo, Japan. |
| Grease 2 | A grease, available under the trade designation “1856”, |
| | from Three Bond Co. Ltd. |
| Grease 3 | A grease, available under the trade designation “1815E”, |
| | from Three Bond Co. Ltd. |
| Grease 4 | A grease, available under the trade designation “1860”, |
| | from Three Bond Co. Ltd. |
| Grease 5 | A grease, available under the trade designation “1925”, |
| | from Three Bond Co. Ltd. |

### Test Method

### Compatibility Test

The compatibility of a cleaning fluid with various polymer substrates was determined by weighing approximately 0.4 to 0.8 g of a polymer substrate and placing it in a 20 ml vial. To the vial, approximately 20 g of a cleaning solution was added. The vial was capped and the polymer substrate was allowed to soak in the cleaning fluid solution for 48 hours. The polymer substrate was removed from the vial and the surface was dried of residual cleaning fluid. The polymer substrate was reweighed and the percent change in weight was recorded, Tables 6A to 6G, 7A to 7D, 8A to 8D, 9A to 9D and 10A to 10B.

### Solubility Test

The solubility of various oils and greases in each cleaning fluid was determined by placing approximately 0.2 g of the oil or grease in a vial. One milliliter of the cleaning fluid was then added to the vial. The vial was sealed and placed in an ultrasonic cleaner (38 KHz, 160 W), available under the trade designation “BRANSONIC 5800H-J” from Emerson Electric Co. Ferguson, Missouri, for one hour. The solution was then observed 10 minutes after ultrasonic application. Solubility of the oils and greases was rated as follows:
9—Dispersed well and no separating.
5—Dispersed with partly separating
1—Insoluble.

Results are shown in Tables 11 to 14.

### Flammability Test

The flammability test was conducted following a procedure according to ASTM D56 Flammability Test for Flash Point by Tag Closed Cup method, using an automatic flash point tester, model RF-301, available from RIGO Co., Ltd, Tokyo, Japan. Results are shown in Table 15

### Examples (Exs) and Comparative Examples (CEs)

Examples and Comparative Examples were prepared by mixing the appropriate ratios of cleaning fluid components, based on weight, and mixing the solution thoroughly, Tables 1 to 5.

TABLE 1
Cleaning Fluid Compositions.

| | | | Ratio Solvent 1/ |
|---|---|---|---|
| | | | Solvent 2 |
| | Solvent 1 | Solvent 2 | (wt./wt.) |
| CE-1A | 1233z | HFTE | 0/100 |
| Ex-1B | 1233z | HFTE | 30/70 |
| Ex-1C | 1233z | HFTE | 50/50 |
| Ex-1D | 1233z | HFTE | 70/30 |
| Ex-1E | 1233z | HFTE | 85/15 |
| Ex-1F | 1233z | HFTE | 95/5 |
| CE-1G | 1233z | HFTE | 100/0 |

TABLE 2
Cleaning Fluid Compositions

| | | | Ratio Solvent 1/ |
|---|---|---|---|
| | | | Solvent 2 |
| | Solvent 1 | Solvent 2 | (wt./wt.) |
| CE-2A | 1233z | SF-70 | 0/100 |
| Ex-2B | 1233z | SF-70 | 30/70 |
| Ex-2C | 1233z | SF-70 | 50/50 |
| Ex-2D | 1233z | SF-70 | 70/30 |
| CE-1G | 1233z | SF-70 | 100/0 |

TABLE 3
Cleaning Fluid Compositions

| | | | Ratio Solvent 1/ |
|---|---|---|---|
| | | | Solvent 2 |
| | Solvent 1 | Solvent 2 | (wt./wt.) |
| CE-3A | 1233z | 7100 | 0/100 |
| CE-3B | 1233z | 7100 | 30/70 |
| CE-3C | 1233z | 7100 | 50/50 |
| CE-3D | 1233z | 7100 | 70/30 |
| CE-1G | 1233z | 7100 | 100/0 |

TABLE 4
Cleaning Fluid Compositions

| | | | Ratio Solvent 1/ |
|---|---|---|---|
| | | | Solvent 2 |
| | Solvent 1 | Solvent 2 | (wt./wt.) |
| CE-4A | 1233z | Hexane | 0/100 |
| CE-4B | 1233z | Hexane | 30/70 |
| CE-4C | 1233z | Hexane | 50/50 |
| CE-4D | 1233z | Hexane | 70/30 |
| CE-1G | 1233z | Hexane | 100/0 |

TABLE 5
Cleaning Fluid Compositions

| | | | | Ratio Solvent 1/ |
|---|---|---|---|---|
| | | | | Solvent 2/Solvent 3 |
| | Solvent 1 | Solvent 2 | Solvent 3 | (wt./wt./wt.) |
| Ex-5A | 1233z | HFTE | SF-70 | 70/15/15 |
| Ex-5B | 1233z | HFTE | SF-70 | 50/25/25 |

TABLE 6A
Compatibility Test Results.

| | | Weight Change | |
|---|---|---|---|
| | Substrate | (%) | Comment |
| CE-1A | LDPE | 0.3 | No visual change |
| CE-1A | ABS | −0.1 | No visual change |
| CE-1A | PC | 0.0 | No visual change |
| CE-1A | EPDM | 1.4 | No visual change |
| CE-1A | SBR | 1.3 | Solution turned |
| | | | light yellow |
| CE-1A | CR | −1.0 | Solution turned |
| | | | yellow |
| CE-1A | NBR | 0.4 | No visual change |

TABLE 6B
Compatibility Test Results.

| | | Weight Change | |
|---|---|---|---|
| | Substrate | (%) | Comment |
| Ex-1B | LDPE | 0.9 | No visual change |
| Ex-1B | ABS | 0.5 | No visual change |
| Ex-1B | PC | 0.0 | No visual change |
| Ex-1B | EPDM | 4.2 | No visual change |
| Ex-1B | SBR | 9.3 | Solution turned |
| | | | light yellow |
| Ex-1B | CR | 1.1 | Solution turned |
| | | | dark yellow |
| Ex-1B | NBR | 18.5 | No visual change |

TABLE 6C
Compatibility Test Results.

| | | Weight Change | |
|---|---|---|---|
| | Substrate | (%) | Comment |
| Ex-1C | LDPE | 1.4 | No visual change |
| Ex-1C | ABS | 9.7 | No visual change |
| Ex-1C | PC | 0.5 | No visual change |
| Ex-1C | EPDM | 5.0 | No visual change |
| Ex-1C | SBR | 12.4 | Solution turns yellow |
| Ex-1C | CR | 0.0 | Solution turned |
| | | | dark yellow |
| Ex-1C | NBR | 26.3 | Solution turned |
| | | | light yellow |

TABLE 6D
Compatibility Test Results.

| | | Weight Change | |
|---|---|---|---|
| | Substrate | (%) | Comment |
| Ex-1D | LDPE | 1.6 | No visual change |
| Ex-1D | ABS | NA | Substrate deformed & softened |
| Ex-1D | PC | 18.2 | Substrate became translucent |
| Ex-1D | EPDM | 6.4 | No visual change |
| Ex-1D | SBR | 15.9 | Solution turned yellow |
| Ex-1D | CR | −0.3 | Solution turned dark yellow |
| Ex-1D | NBR | 50.3 | Solution turned light yellow |

TABLE 6E
Compatibility Test Results.

| | | Weight Change | |
|---|---|---|---|
| | Substrate | (%) | Comment |
| Ex-1E | LDPE | 1.7 | No visual change |
| Ex-1E | ABS | — | Substrate softens |
| Ex-1E | PC | 35.5 | Substrate turned hazy |
| Ex-1E | EPDM | 7.8 | Solution discoloration |
| Ex-1E | SBR | 19.8 | Solution turned |
| | | | dark yellow |
| Ex-1E | CR | 1.5 | Solution turned |
| | | | dark yellow |
| Ex-1E | NBR | 75.7 | Solution turned |
| | | | light yellow |

TABLE 6F
Compatibility Test Results.

| | | Weight Change | |
|---|---|---|---|
| | Substrate | (%) | Comment |
| Ex-1F | LDPE | 1.9 | No visual change |
| Ex-1F | ABS | — | Substrate disintegrated |
| Ex-1F | PC | 45.9 | Substrate turned hazy |
| Ex-1F | EPDM | 8.5 | Solution discoloration |
| Ex-1F | SBR | 22.6 | Solution turned |
| | | | dark yellow |
| Ex-1F | CR | 2.3 | Solution turned |
| | | | dark yellow |
| Ex-1F | NBR | 93.3 | Solution turned |
| | | | yellow |

TABLE 6G
Compatibility Test Results.

| | | Weight Change | |
|---|---|---|---|
| | Substrate | (%) | Comment |
| CE-1G | LDPE | 2.0 | No visual change |
| CE-1G | ABS | — | Substrate disintegrated |
| CE-1G | PC | 47.3 | Substrate becomes |
| | | | translucent |
| CE-1G | EPDM | 8.0 | No visual change |
| CE-1G | SBR | 22.6 | Solution turned |
| | | | dark yellow |
| CE-1G | CR | 2.5 | Solution turned |
| | | | dark yellow |
| CE-1G | NBR | 93.1 | Solution turned |
| | | | light yellow |

TABLE 7A
Compatibility Test Results.

| | | Weight Change | |
|---|---|---|---|
| | Substrate | (%) | Comment |
| CE-2A | LDPE | 0.1 | No visual change |
| CE-2A | ABS | −0.1 | No visual change |
| CE-2A | PC | −0.1 | No visual change |
| CE-2A | EPDM | −0.2 | No visual change |
| CE-2A | SBR | −0.1 | No visual change |
| CE-2A | CR | 0.0 | No visual change |
| CE-2A | NBR | −0.2 | No visual change |

TABLE 7B
Compatibility Test Results.

| | | Weight Change | |
|---|---|---|---|
| | Substrate | (%) | Comment |
| Ex-2B | LDPE | 1.2 | No visual change |
| Ex-2B | ABS | 3.3 | No visual change |
| Ex-2B | PC | 0.7 | No visual change |
| Ex-2B | EPDM | 4.7 | No visual change |
| Ex-2B | SBR | 10.6 | Solution turned |
| | | | dark yellow |
| Ex-2B | CR | 5.2 | Solution turned |
| | | | light yellow |
| Ex-2B | NBR | 16.6 | No visual change |

TABLE 7C
Compatibility Test Results.

| | | Weight Change | |
|---|---|---|---|
| | Substrate | (%) | Comment |
| Ex-2C | LDPE | 1.4 | No visual change |
| Ex-2C | ABS | 25.6 | Substrate deformed |
| Ex-2C | PC | 5.5 | No visual change |
| Ex-2C | EPDM | 5.1 | No visual change |
| Ex-2C | SBR | 12.1 | Solution turned |
| | | | dark yellow |
| Ex-2C | CR | 0.8 | Solution turned |
| | | | dark yellow |
| Ex-2C | NBR | 23.2 | Solution turned |
| | | | light yellow |

TABLE 7D
Compatibility Test Results.

| | | Weight Change | |
|---|---|---|---|
| | Substrate | (%) | Comment |
| Ex-2D | LDPE | 1.7 | No visual change |
| Ex-2D | ABS | NA | Substrate deformed & softened |
| Ex-2D | PC | 20.8 | Substrate becomes translucent |
| Ex-2D | EPDM | 5.4 | No visual change |
| Ex-2D | SBR | 13.7 | Solution turned dark yellow |
| Ex-2D | CR | −0.5 | Solution turned dark yellow |
| Ex-2D | NBR | 36.0 | Solution turned light yellow |

TABLE 8A
Compatibility Test Results.

| | | Weight Change | |
|---|---|---|---|
| | Substrate | (%) | Comment |
| CE-3A | LDPE | 0.1 | No visual change |
| CE-3A | ABS | 0.0 | No visual change |
| CE-3A | PC | −0.2 | No visual change |
| CE-3A | EPDM | −0.3 | No visual change |
| CE-3A | SBR | −0.4 | No visual change |
| CE-3A | CR | −0.7 | No visual change |
| CE-3A | NBR | −0.3 | No visual change |

TABLE 8B
Compatibility Test Results.

| | | Weight Change | |
|---|---|---|---|
| | Substrate | (%) | Comment |
| Ex-3B | LDPE | 0.8 | No visual Change |
| Ex-3B | ABS | 0.5 | No visual Change |
| Ex-3B | PC | 0.1 | No visual Change |
| Ex-3B | EPDM | 2.4 | No visual Change |
| Ex-3B | SBR | 5.7 | No visual Change |
| Ex-3B | CR | 1.0 | Solution turned light yellow |
| Ex-3B | NBR | 11.8 | No visual change |

TABLE 8C
Compatibility Test Results.

| | | Weight Change | |
|---|---|---|---|
| | Substrate | (%) | Comment |
| Ex-3C | LDPE | 1.2 | No visual change |
| Ex-3C | ABS | 3.3 | No visual change |
| Ex-3C | PC | 0.6 | No visual change |
| Ex-3C | EPDM | 3.6 | No visual change |
| Ex-3C | SBR | 8.5 | Solution turned light yellow |
| Ex-3C | CR | 0.3 | Solution turned yellow |
| Ex-3C | NBR | 17.3 | Solution turned light yellow |

TABLE 8D
Compatibility Test Results.

| | | Weight Change | |
|---|---|---|---|
| | Substrate | (%) | Comment |
| Ex-3D | LDPE | 1.6 | No visual change |
| Ex-3D | ABS | 53.8 | Substrate slightly swelled and |
| | | | became slightly transparent |
| Ex-3D | PC | 12.1 | Substrate became translucent |
| Ex-3D | EPDM | 4.8 | No visual change |
| Ex-3D | SBR | 12.1 | Solution turned light yellow |
| Ex-3D | CR | −1.1 | Solution turned yellow |
| Ex-3D | NBR | 32.7 | Solution turned light yellow |

TABLE 9A
Compatibility Test Results.

| | | Weight Change | |
|---|---|---|---|
| | Substrate | (%) | Comment |
| CE-4A | LDPE | 9.0 | No visual change |
| CE-4A | ABS | 0.6 | No visual change |
| CE-4A | PC | 0.0 | No visual change |
| CE-4A | EPDM | 51.1 | No visual change |
| CE-4A | SBR | 32.9 | Solution turned dark yellow |
| CE-4A | CR | 5.9 | Solution turned dark yellow |
| CE-4A | NBR | 5.1 | No visual change |

TABLE 9B
Compatibility Test Results.

| | | Weight Change | |
|---|---|---|---|
| | Substrate | (%) | Comment |
| Ex-4B | LDPE | 9.4 | No visual change |
| Ex-4B | ABS | 21.9 | No visual change |
| Ex-4B | PC | 0.5 | No visual change |
| Ex-4B | EPDM | 57.0 | No visual change |
| Ex-4B | SBR | 62.9 | Solution turned dark yellow |
| Ex-4B | CR | 17.5 | Solution turned dark yellow |
| Ex-4B | NBR | 11.5 | Solution turned light yellow |

TABLE 9C
Compatibility Test Results.

| | | Weight Change | |
|---|---|---|---|
| | Substrate | (%) | Comment |
| Ex-4C | LDPE | 9.0 | No visual change |
| Ex-4C | ABS | — | Substrate Soften |
| Ex-4C | PC | 8.3 | Substrate becomes translucent |
| Ex-4C | EPDM | 46.4 | No visual change |
| Ex-4C | SBR | 74.9 | Solution turned dark yellow |
| Ex-4C | CR | 23.4 | Solution turned dark yellow |
| Ex-4C | NBR | 29.3 | Solution turned yellow |

TABLE 9D
Compatibility Test Results.

| | | Weight Change | |
|---|---|---|---|
| | Substrate | (%) | Comment |
| Ex-4D | LDPE | 8.2 | No visual change |
| Ex-4D | ABS | — | Substrate Disintegrated |
| Ex-4D | PC | 25.6 | Substrate became opaque |
| Ex-4D | EPDM | 36.8 | No visual change |
| Ex-4D | SBR | 70.0 | Solution turned dark yellow |
| Ex-4D | CR | 22.1 | Solution turned dark yellow |
| Ex-4D | NBR | 51.6 | Solution turned yellow |

TABLE 10A
Compatibility Test Results.

| | | Weight Change | |
|---|---|---|---|
| | Substrate | (%) | Comment |
| Ex-5A | LDPE | 1.6 | No visual change |
| Ex-5A | ABS | 67.0 | Substrate deformed |
| Ex-5A | PC | 15.9 | Substrate turned hazy |
| Ex-5A | EPDM | 6.1 | No visual change |
| Ex-5A | SBR | 15.3 | Solution turned dark yellow |
| Ex-5A | CR | 0.8 | Solution turned dark yellow |
| Ex-5A | NBR | 38.1 | Solution turned slight yellow |

TABLE 10B
Compatibility Test Results.

| | | Weight Change | |
|---|---|---|---|
| | Substrate | (%) | Comment |
| Ex-5B | LDPE | 1.3 | No visual change |
| Ex-5B | ABS | 9.4 | No visual change |
| Ex-5B | PC | 0.8 | No visual change |
| Ex-5B | EPDM | 5.1 | No visual change |
| Ex-5B | SBR | 11.9 | Solution turned yellow |
| Ex-5B | CR | 1.4 | Solution turned dark yellow |
| Ex-5B | NBR | 22.2 | Solution turned light yellow |

TABLE 11
Solubility Test Results.

| | CE-1A | Ex-1B | Ex-1C | Ex-1D | CE-1G |
|---|---|---|---|---|---|
| Oil 1 | 5 | 9 | 9 | 9 | 9 |
| Oil 2 | 5 | 9 | 9 | 9 | 9 |
| Grease 1 | 1 | 9 | 9 | 9 | 9 |
| Grease 2 | 1 | 9 | 9 | 9 | 9 |
| Grease 3 | 1 | 9 | 9 | 9 | 9 |
| Grease 4 | 1 | 9 | 9 | 9 | 9 |
| Grease 5 | 1 | 9 | 9 | 9 | 9 |
| Average | 2.1 | 9 | 9 | 9 | 9 |

TABLE 12
Solubility Test Results.

| | CE-2A | Ex-2B | Ex-2C | Ex-2D | CE-1G |
|---|---|---|---|---|---|
| Oil 1 | 1 | 1 | 1 | 5 | 9 |
| Oil 2 | 1 | 5 | 5 | 5 | 9 |
| Grease 1 | 1 | 5 | 5 | 9 | 9 |
| Grease 2 | 1 | 1 | 1 | 9 | 9 |
| Grease 3 | 1 | 1 | 9 | 9 | 9 |
| Grease 4 | 1 | 1 | 5 | 9 | 9 |
| Grease 5 | 1 | 5 | 5 | 9 | 9 |
| Average | 1 | 2.7 | 4.4 | 7.8 | 9 |

TABLE 13
Solubility Test Results.

| | CE-3A | Ex-3B | Ex-3C | Ex-3D | CE-1G |
|---|---|---|---|---|---|
| Oil 1 | 5 | 5 | 5 | 5 | 9 |
| Oil 2 | 5 | 5 | 5 | 5 | 9 |
| Grease 1 | 1 | 1 | 1 | 9 | 9 |
| Grease 2 | 1 | 5 | 9 | 9 | 9 |
| Grease 3 | 1 | 9 | 9 | 9 | 9 |
| Grease 4 | 1 | 9 | 9 | 9 | 9 |
| Grease 5 | 1 | 9 | 9 | 9 | 9 |
| Average | 2.1 | 6.1 | 6.7 | 7.8 | 9 |

TABLE 14
Solubility Test Results.

| | CE-4A | CE-1G |
|---|---|---|
| Oil 1 | 9 | 9 |
| Oil 2 | 9 | 9 |
| Grease 1 | 9 | 9 |
| Grease 2 | 9 | 9 |
| Grease 3 | 9 | 9 |
| Grease 4 | 9 | 9 |
| Grease 5 | 9 | 9 |
| Average | 9 | 9 |

TABLE 15
Flammability Test Results

| CE-1A | Ex-1B | Ex-1C | Ex-1D | CE-1G | CE-4B | CE-4C |
|---|---|---|---|---|---|---|
| NF, boiled | NF, boiled | NF, boiled | NF, boiled | NF, boiled | Flammable, | Flammable, |
| at 62° C. | at 44° C. | at 42° C. | at 42° C. | at 39° C. | burned at | burned at |
| | | | | | 38.5° C. | 34.5° C. |

NF = Non-Flammable

What is claimed is:

1. A cleaning fluid comprising:
a first fluid component comprising a chlorinated hydrofluoroolefin or a hydrochlorofluoroolefin or mixture of hydrochlorofluoroolefins;
at least one second fluid component, the second fluid component comprising at least one of:
a hydrofluorothioether comprising structure 4:
R¹—S—CR_{f}¹R_{f}²F Structure 4
wherein R¹ is an alkyl group with 1-3 carbon atoms;
R_{f}¹ and R_{f}² are independently selected from perfluorinated alkyl groups with 1-3 carbon atoms;
a perfluorinated olefin comprising at least 6 carbon atoms;
a hydrofluorolefin comprising at least 6 carbon atoms;
a perfluorinated olefin mixture wherein the perfluorinated olefins comprise at least 6 carbon atoms; or
a hydrofluorolefin mixture wherein the hydrofluorolefins comprise at least 6 carbon atoms.

2. The cleaning fluid of claim 1, wherein the first fluid component comprises a chlorinated hydrofluoroolefin of Structure 1
cis-(CF₃)HC═CHCl; Structure 1
or a at least one of the two isomers of hydrochlorofluoroolefin of Structure 2,
HClC═CF(CF₂H) Structure 2
at least one of the two isomers of hydrochlorofluoroolefin of Structure 3,
FClC═CH(CF₂H) Structure 3
or a mixture thereof.

3. The cleaning fluid of claim 1, wherein the first fluid component comprises 30-95% by weight of the total of the first and second fluid components of the cleaning fluid.

4. The cleaning fluid of claim 1 wherein the first fluid component comprises 30-70% by weight of the total of the first and second fluid components of the cleaning fluid.

5. The cleaning fluid of claim 1 wherein the first fluid component comprises 40-50% by weight of the total of the first and second fluid components of the cleaning fluid.

6. The cleaning fluid of claim 1, wherein the second fluid component comprises a compound of Structure 4 wherein R¹ is a methyl group; and R_{f}¹ and R_{f}² are perfluorinated methyl groups.

7. The cleaning fluid of claim 1, wherein the cleaning fluid is non-flammable.

8. The cleaning fluid of claim 1, wherein the cleaning fluid is sprayable.

9. The cleaning fluid of claim 1, wherein the cleaning fluid has a boiling point of less than 100° C.

10. The cleaning fluid of claim 1, wherein the cleaning fluid is compatible with the plastic and rubber materials selected from LDPE (low density polyethylene), ABS (acrylonitrile butadiene styrene copolymer), PC (polycarbonate), EPDM (ethylene propylene diene monomer synthetic rubber), CR (chloroprene rubber), SBR (styrene butadiene rubber), wherein compatibility is measured by a weight increase of less than 10% when soaked for 48 hours in the cleaning fluid.

11. The cleaning fluid of claim 1, wherein the cleaning fluid comprises at least 3 fluid components comprising:
a first fluid component comprising a chlorinated hydrofluoroolefin or a hydrochlorofluoroolefin or mixture of hydrochlorofluoroolefins;
a second fluid component comprising a hydrofluorothioether comprising structure 4:
R¹—S—CR_{f}¹R_{f}²F Structure 4
wherein R¹ is an alkyl group with 1-3 carbon atoms;
R_{f}¹ and R_{f}² are independently selected from perfluorinated alkyl groups with 1-3 carbon atoms; and
a third fluid component comprising:
a perfluorinated olefin comprising at least 6 carbon atoms;
a hydrofluorolefin comprising at least 6 carbon atoms;
a perfluorinated olefin mixture wherein the perfluorinated olefins comprise at least 6 carbon atoms; or
a hydrofluorolefin mixture wherein the hydrofluorolefins comprise at least 6 carbon atoms.

12. The cleaning fluid of claim 11, wherein the first fluid component comprises a chlorinated hydrofluoroolefin of Structure 1
cis-(CF₃)HC═CHCl; Structure 1
or a at least one of the two isomers of hydrochlorofluoroolefin of Structure 2,
HClC═CF(CF₂H) Structure 2
at least one of the two isomers of hydrochlorofluoroolefin of Structure 3,
FClC═CH(CF₂H) Structure 3
or a mixture thereof.

13. The cleaning fluid of claim 11, wherein the third fluid component comprises:
a perfluorinated olefin comprising at least 6 carbon atoms; or
a perfluorinated olefin mixture wherein the perfluorinated olefins comprise at least 6 carbon atoms.

14. The cleaning fluid of claim 11, wherein the first fluid component comprises 30-70% by weight; the second fluid component comprises at least 15% by weight; and the third fluid component comprises at least 15% by weight, wherein the % by weight is the % by weight of the total of the first, second and third fluid components of the cleaning fluid.
